(19) United States
(12) Patent Application Publication
(10) Pub. No.: US 2016/0112609 A1
(43) Pub. Date: Apr. 21, 2016

(54) MONITORING APPARATUS

(71) Applicant: Vivotek Inc., New Taipei City (TW)

(72) Inventors: Hsiang-Lin Hsu, New Taipei City (TW); Yuan-Han Chang, New Taipei City (TW)

(21) Appl. No.: 14/854,049

(22) Filed: Sep. 15, 2015

(30) Foreign Application Priority Data
Oct. 20, 2014 (TW) 103136205

(51) Int. Cl. H04N 5/225

(52) U.S. Cl. CPC H04N 5/2253

(57) ABSTRACT

A monitoring apparatus includes a main body, a mounting plate, and a fixing plate. The mounting plate is connected to the main body and has a first bending rib structure protrusively formed thereon. The fixing plate is fixed to a mounting target and is disposed opposite to the mounting plate. The fixing plate has a first opening structure formed thereon corresponding to the first bending rib structure and a second bending rib structure laterally extending from the first opening structure. When the mounting plate is connected to the fixing plate to make the first bending rib structure pass through the first opening structure, the first bending rib structure rotates with rotation of the mounting plate relative to the fixing plate to be engaged with the second bending rib structure, so as to fix the mounting plate to the fixing plate.

### BACKGROUND OF THE INVENTION

1. Field of the Invention

The present invention relates to a monitoring apparatus, and more specifically, to a monitoring apparatus utilizing a bending rib structure on a mounting plate to rotate to be engaged with a bending rib structure on a fixing plate for fixing a main body on a mounting target.

2. Description of the Prior Art

In general, a monitoring apparatus (e.g. a monitoring camera) is usually disposed on a ceiling structure or a wall for image surveillance. A conventional mounting method is to fix a fixing plate on the ceiling structure or the wall by a screw locking process and then screw the monitoring apparatus on the fixing plate, so as to mount the monitoring apparatus on the ceiling structure or the wall. However, during the aforesaid mounting process, since a user needs to utilize a screwing tool (e.g. a screw driver) to perform a screw locking operation on the monitoring apparatus, it occurs easily that the monitoring apparatus falls from the user's hands accidentally to cause damage of the monitoring apparatus. Moreover, this mounting method also causes much inconvenience in mounting the monitoring apparatus since the aforesaid screw locking operation is time-consuming and strenuous.

### SUMMARY OF THE INVENTION

The present invention provides a monitoring apparatus including a main body, a mounting plate, and a fixing plate. The mounting plate is connected to the main body. A first bending rib structure protrudes from the mounting plate. The fixing plate is fixed to a mounting target and disposed opposite to the mounting plate. The fixing plate has a first opening structure corresponding to the first bending rib structure and a second bending rib structure laterally extending from the first opening structure. The first bending rib structure rotates with rotation of the mounting plate relative to the fixing plate to be engaged with the second bending rib structure when the mounting plate is connected to the fixing plate to make the first bending rib structure pass through the first opening structure, so as to fix the mounting plate to the fixing plate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial exploded diagram of a monitoring apparatus according to a first embodiment of the present invention.

FIG. 2 is a diagram of a fixing plate in FIG. 1 at another viewing angle.

FIG. 3 is a diagram of the monitoring apparatus in FIG. 1 being fixed to a ceiling structure.

FIG. 4 is a partial exploded diagram of a monitoring apparatus according to a second embodiment of the present invention.

FIG. 5 is a diagram of an adapting plate in FIG. 4 at another viewing angle.

FIG. 6 is a diagram of the monitoring apparatus in FIG. 4 being hung on a mounting wall.

FIG. 7 is a partial exploded diagram of a monitoring apparatus according to a third embodiment of the present invention.

FIG. 8 is a diagram of a fixing plate in FIG. 7 at another viewing angle.

FIG. 9 is a diagram of the monitoring apparatus in FIG. 7 being embedded in a ceiling structure.

### DETAILED DESCRIPTION

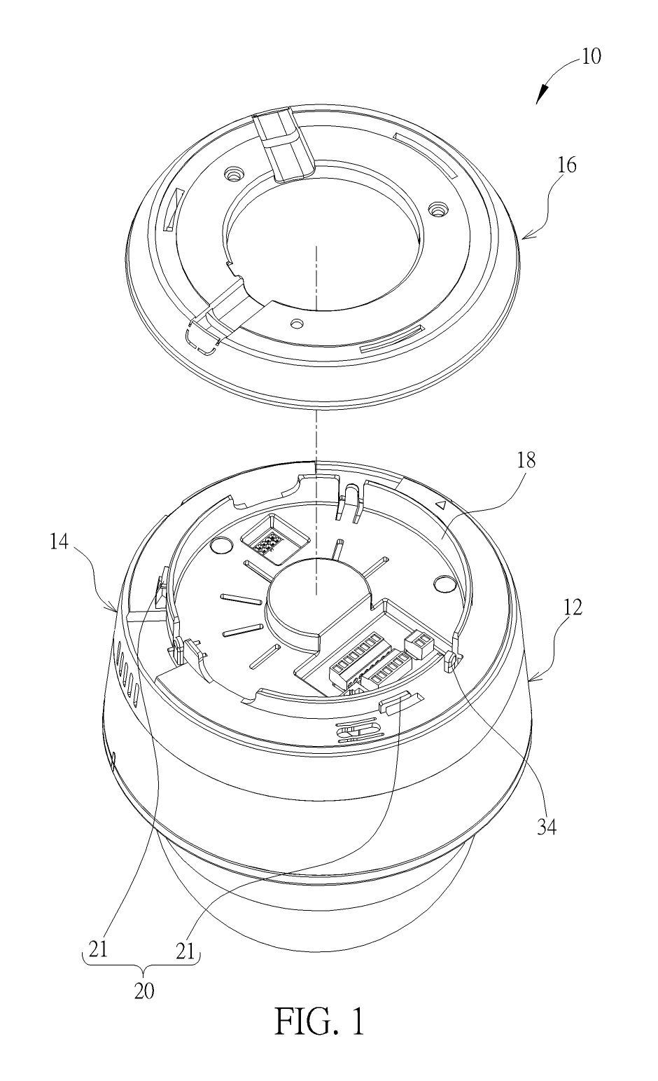

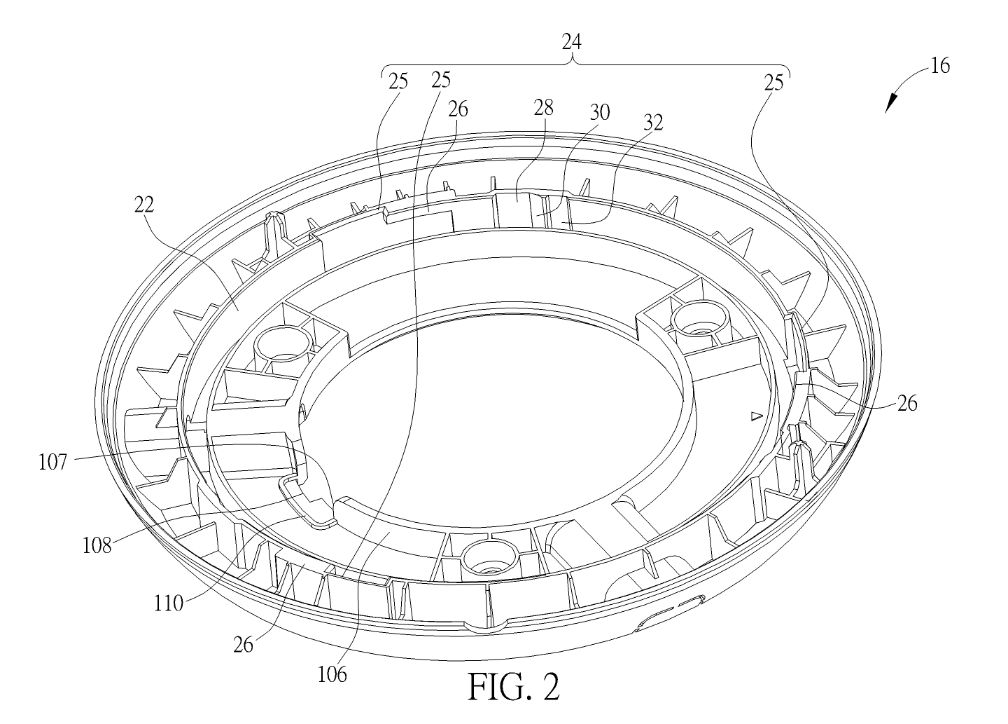

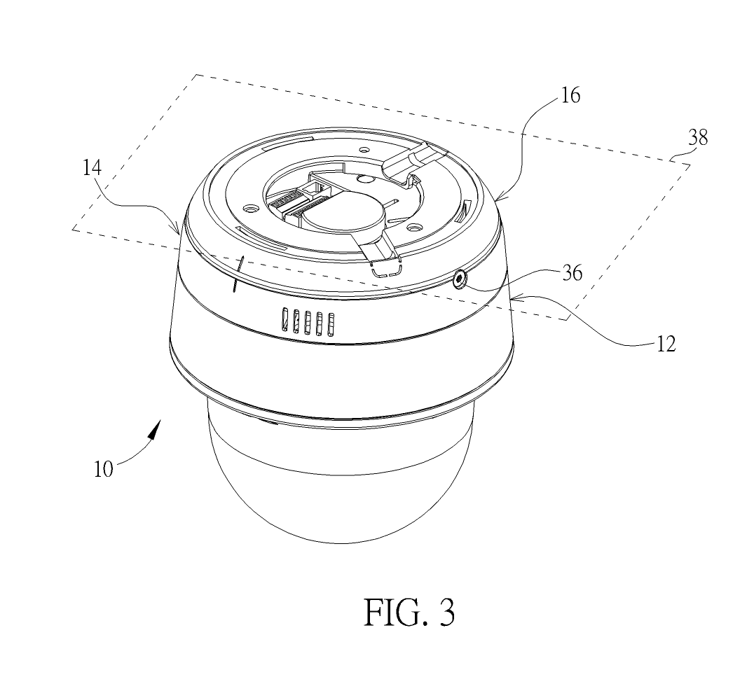

Please refer to FIG. 1, FIG. 2, and FIG. 3. FIG. 1 is a partial exploded diagram of a monitoring apparatus 10 according to a first embodiment of the present invention. FIG. 2 is a diagram of a fixing plate in FIG. 1 at another viewing angle. FIG. 3 is a diagram of the monitoring apparatus 10 in FIG. 1 being fixed to a ceiling structure 38. As shown in FIG. 1 and FIG. 2, the monitoring apparatus 10 includes a main body 12 (e.g. a monitoring camera body), a mounting plate 14, and a fixing plate 16. The main body 12 could include major components disposed on a conventional monitoring camera (e.g. an image capturing lens, a light source, a circuit board, and a lamp cover), and the related description could be omitted herein since it is commonly seen in the prior art. The mounting plate 14 is connected to the main body 12 and is used for connecting to the fixing plate 16. The fixing plate 16 is used for fixing to a mounting target (e.g. a ceiling) and is disposed opposite to the mounting plate 14. To be more specific, as shown in FIG. 1 and FIG. 2, in this embodiment, a guiding ring structure 18 and a bending rib structure 20 protrude from the mounting plate 14. The fixing plate 16 has a guiding ring structure 22 protruding therefrom. An opening structure 24 is formed on the fixing plate 16 corresponding to the bending rib structure 20 and a bending rib structure 26 laterally extends from the opening structure 24. The bending rib structure 20 is formed on the guiding ring structure 18. The opening structure 24 and the bending rib structure 26 are formed on the guiding ring structure 22. A size of the guiding ring structure 22 could be preferably greater than a size of the guiding ring structure 18, so as to make the guiding ring structure 22 sleeve the first guiding ring structure 18 for guiding the mounting plate 14 to rotate on the fixing plate 16 when the mounting plate 14 is connected to the fixing plate 16 and for constraining spatial degrees of freedom of the mounting plate 14 relative to the fixing plate 16.

Furthermore, the guiding ring structure 22 has a sliding slot 28, an inclined-surface structure 30, and a fixing slot 32 extending from a side of the bending rib structure 26. The inclined-surface structure 30 is located between the sliding slot 28 and the fixing slot 32. The mounting plate 14 has an elastic arm 34 protruding therefrom corresponding to the sliding slot 28. The elastic arm 34 is movably inserted into the sliding slot 28. Accordingly, when the mounting plate 14 rotates relative to the fixing plate 16, the elastic arm 34 could cross the inclined-surface structure 30 along the sliding slot 28 to be engaged with the fixing slot 32.

In practical application, the bending rib structure 20 of the mounting plate 14 could include three bending ribs 21 (two only shown in FIG. 1 due to the viewing angle, but not limited thereto, meaning that amount of the ribs 21 could vary with the practical application of the monitoring apparatus 10). The three bending ribs 21 are alternately formed on the guiding ring structure 18 of the mounting plate 14. The opening structure 24 of the fixing plate 16 could include three openings 25 respectively corresponding to the three bending ribs 21. A size of each bending rib 21 is different from each other and conforms to a size of the corresponding opening 25, so as to make each bending rib 21 only pass through the corresponding opening 25. Accordingly, only when the mounting plate 14 rotates to a correct position relative to the fixing plate 16, the bending ribs 21 could pass through the corresponding openings 25 respectively for foolproof, so as to prevent the mounting plate 14 from being jammed with the fixing plate 16 due to a user's incorrect operations. Furthermore, the monitoring apparatus 10 could include at least one tamper proof screw 36 (one shown in FIG. 3, but not limited thereto). The tamper proof screw 36 is used for fixing the mounting plate 14 on the fixing plate 16 when the bending rib structure 20 rotates to be engaged with the bending rib structure 26, so as to generate the anti-theft effect. That is to say, when the mounting plate 14 rotates relative to the fixing plate 16, fixing of the tamper proof screw 36 could prevent the mounting plate 14 from rotating relative to the fixing plate 16 after the bending rib structure 20 and the elastic arm 34 are engaged with the bending rib structure 26 and the fixing slot 32 respectively.

Via the aforesaid design, when a user wants to mount the monitoring apparatus 10 on a mounting target (i.e. a ceiling structure 38 depicted by dotted lines in FIG. 3), the user just needs to fix the mounting plate 14 on the ceiling structure 38 in advance and then connects the main body 12 to the mounting plate 14 (e.g. by a screwing locking process). To be noted, in another embodiment, a monitoring apparatus manufacturer could connect the main body 12 to the mounting plate 14 in advance before delivering a monitoring apparatus for installation convenience. Subsequently, the user could sleeve the guiding ring structure 22 of the fixing plate 16 on the guiding ring structure 18 of the mounting plate 14, and then could rotate the main body 12 to make the mounting plate 14 rotate relative the fixing plate 16. During the aforesaid process, each bending rib 21 could rotates to be aligned with the corresponding opening 25 on the guiding ring structure 22 with rotation of the mounting plate 14 relative to the fixing plate 16, so that the user could push the main body 12 upward to make each bending rib 21 pass through the corresponding opening 25 and make the elastic arm 34 located at a side of the bending rib 21 inserted into the sliding slot 28. Subsequently, the user could keep rotating the main body 12 until each bending rib 21 rotates to be engaged with the corresponding the bending rib structure 26 and the elastic arm 34 could cross the inclined-surface structure 30 along the sliding slot 28 to be engaged with the fixing slot 32 so as to remind the user of stopping rotating the main body 12. Accordingly, via engagement of each bending rib 21 and the corresponding bending rib structure 26 and engagement of the elastic arm 34 and the fixing slot 32, the user could mount the monitoring apparatus 10 on the ceiling structure 38 (as shown in FIG. 3) quickly and conveniently without additionally utilizing a screwing tool (e.g. a screw driver), so as to efficiently solve prior art problem that the mounting process of the monitoring apparatus is time-consuming and strenuous and the monitoring apparatus falls from the user's hands easily during the mounting process to cause damage of the monitoring apparatus. In such a manner, the mounting convenience and safety of the monitoring apparatus 10 is greatly improved.

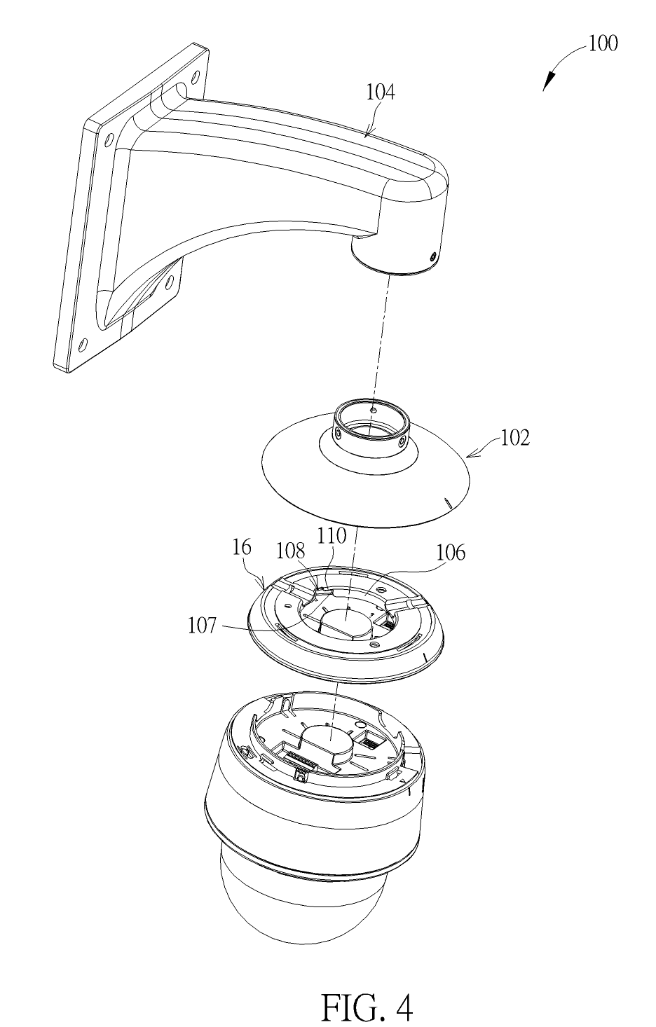

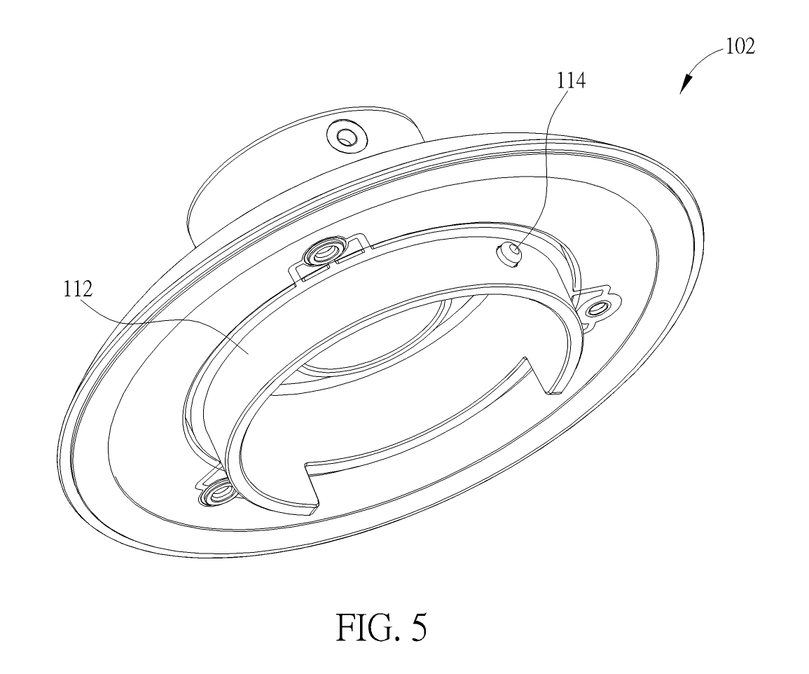

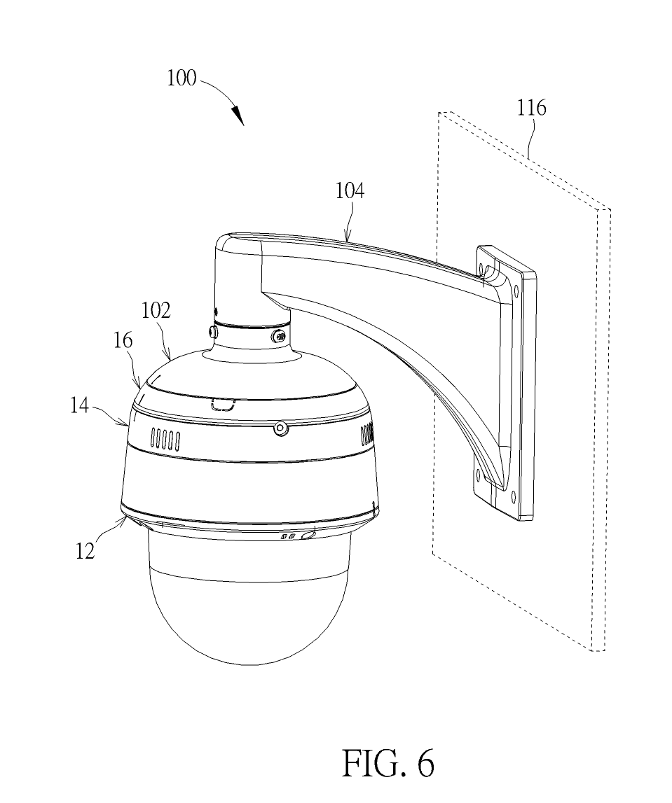

The monitoring apparatus provided by the present invention could also be hung on a mounting wall or be embedded in a ceiling structure. For example, please refer to FIG. 2, FIG. 4, FIG. 5, and FIG. 6. FIG. 4 is a partial exploded diagram of a monitoring apparatus 100 according to a second embodiment of the present invention. FIG. 5 is a diagram of an adapting plate 102 in FIG. 4 at another viewing angle. FIG. 6 is a diagram of the monitoring apparatus 100 in FIG. 4 being hung on a mounting wall 116. In this embodiment, components both mentioned in the first embodiment and the second embodiment represent components with similar functions or structures. In this embodiment, as shown in FIG. 2, FIG. 4, and FIG. 5, the monitoring apparatus 100 includes the main body 12, the mounting plate 14, the fixing plate 16, the adapting plate 102, and an arm tube 104. The fixing plate 16 further has a guiding ring structure 106, an opening structure 108, and a containing slot 110 laterally extending from the opening structure 108. The guiding ring structure 106 has an opening structure 107. The opening structure 108 and the containing slot 110 are formed on the opening structure 107 of the guiding ring structure 106. The adapting plate 102 is used for connecting to the arm tube 104 and the fixing plate 16 and has a guiding ring structure 112 protruding therefrom and a protruding portion 114. A size of the guiding ring structure 112 is preferably less than a size of the guiding ring structure 106, so that the guiding ring structure 106 sleeves the guiding ring structure 112 when the fixing plate 16 is connected to the adapting plate 102 for guiding the fixing plate 16 to rotate relative to the adapting plate 102.

Via the aforesaid design, when the user wants to mount the monitoring apparatus 100 on a mounting target (i.e. the mounting wall 116 depicted by dotted lines in FIG. 6), the user just needs to fix the arm tube 104 on the mounting wall 116 and then connects the adapting plate 102 to the arm tube 104 (e.g. by a screw locking process). Subsequently, the user could sleeve the guiding ring structure 106 of the fixing plate 16 on the guiding ring structure 112 of the adapting plate 102, and could rotate the fixing plate 16 relative to the adapting plate 102. During the aforesaid process, the protruding portion 114 could rotate to be aligned with the opening structure 108 with rotation of the fixing plate 16 relative to the adapting plate 102, so that the user could push the fixing plate 16 upward to make the protruding portion 114 pass through the opening structure 108. Subsequently, the user could continue rotating the fixing plate 16 until the protruding portion 114 rotates to abut against the containing slot 110 as shown in FIG. 2. At this time, the protruding portion 114 could be engaged with the containing slot 110 to make the fixing plate 16 disposed on the adapting plate 102. Accordingly, the user's hands are available to fix the fixing plate 16 on the adapting plate 102 by a screw locking process. Finally, assembly of the mounting plate 14, the main body 12, and the fixing plate 16 could be completed according to the assembly process aforementioned in the first embodiment. In such a manner, via the connecting design that the protruding portion 114 rotates to abut against the containing slot 110, the user could assemble the fixing plate 16 with the adapting plate 102 in advance to make the fixing plate 16 disposed on the adapting plate 102 even if the fixing plate 16 is not supported by the user's hands, so that the user could complete assembly of the mounting plate 14, the main body 12, and the fixing plate 16 quickly and conveniently for hanging the monitoring apparatus 100 on the mounting wall 116 (as shown in FIG. 6). In such a manner, the present invention could efficiently solve the prior art problem that the mounting process of the monitoring apparatus is time-consuming and strenuous and the monitoring apparatus falls from the user's hands easily during the mounting process to cause damage of the monitoring apparatus, so as to greatly improve the mounting convenience and safety of the monitoring apparatus 100.

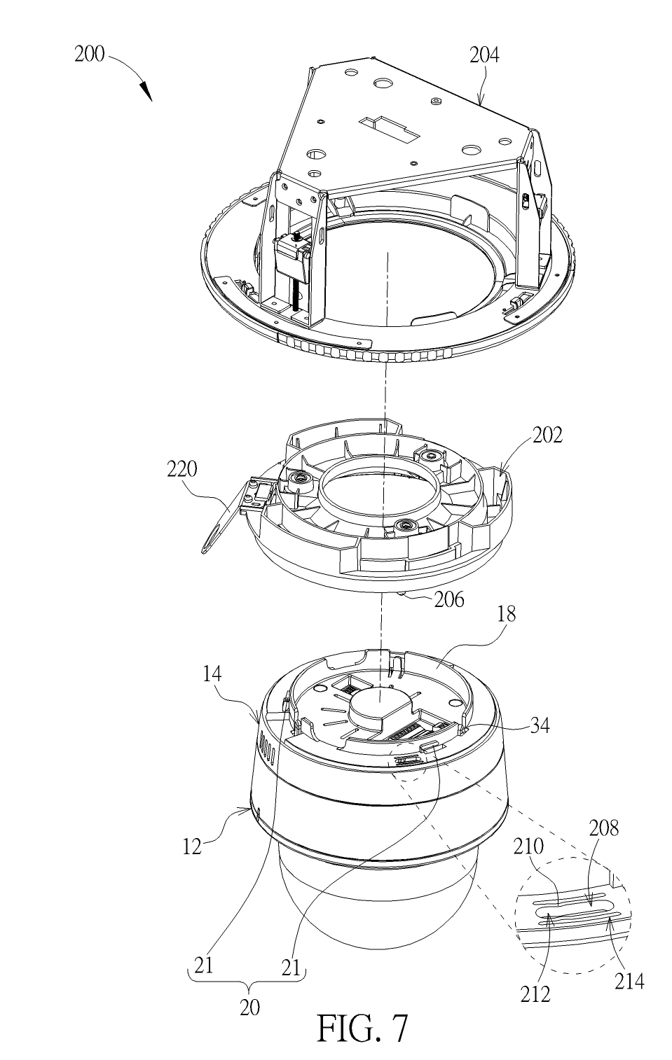

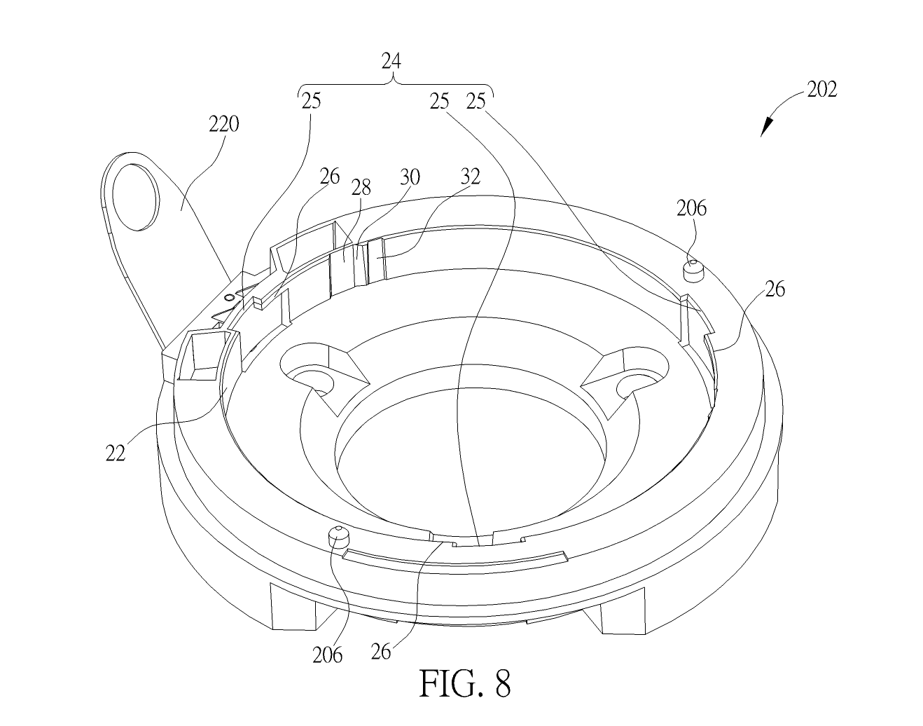

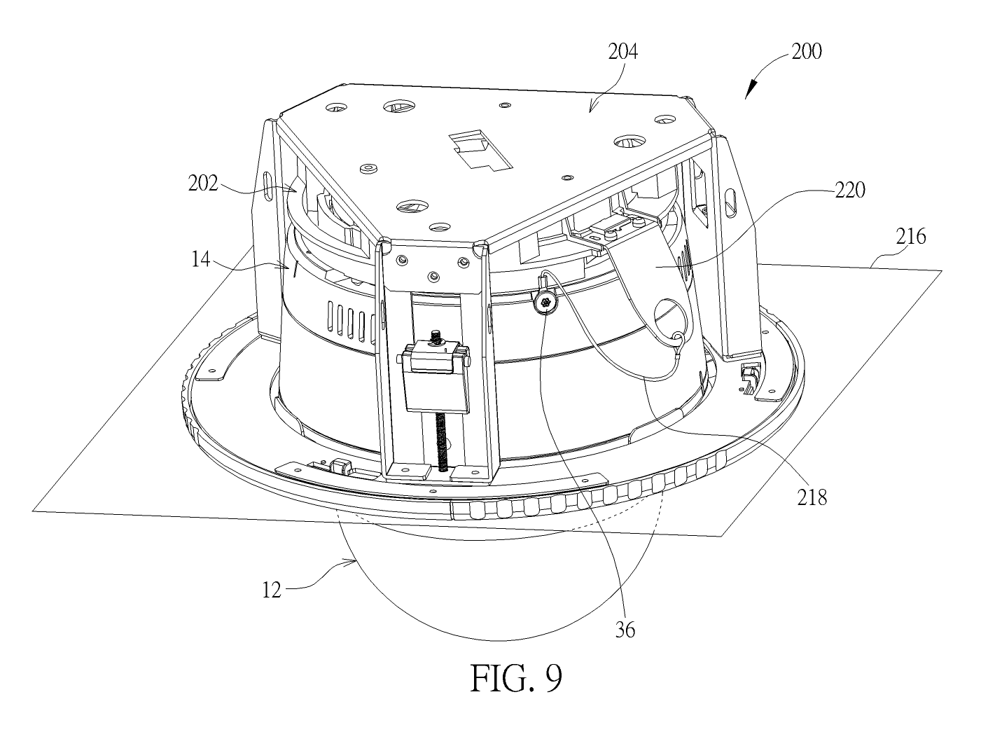

Furthermore, please refer to FIG. 7, FIG. 8, and FIG. 9. FIG. 7 is a partial exploded diagram of a monitoring apparatus 200 according to a third embodiment of the present invention. FIG. 8 is a diagram of a fixing plate 202 in FIG. 7 at another viewing angle. FIG. 9 is a diagram of the monitoring apparatus 200 in FIG. 7 being embedded in a ceiling structure 216. Components both mentioned in this embodiment and the aforesaid embodiments represent components with similar functions or structures, and the related description is omitted herein. In this embodiment, as shown in FIG. 7 and FIG. 8, the monitoring apparatus 200 includes the main body 12, the mounting plate 14, the fixing plate 202, and an embedded frame 204. The guiding ring structure 22 protrudes from the fixing plate 202. The fixing plate 202 has the opening structure 24 corresponding to the bending rib structure 20 of the mounting plate 14 and the bending rib structure 26 laterally extending from the opening structure 24. The guiding ring structure 22 has the sliding slot 28, the inclined-surface structure 30, and the fixing slot 32 extending from a side of the bending rib structure 26, so that the elastic arm 34 of the mounting plate 14 could cross the inclined-surface structure 30 along the sliding slot 28 to be engaged with the fixing slot 32. As mentioned in the aforesaid embodiments, the bending rib structure 20 could include the three bending ribs 21 (only two shown in FIG. 7 due to the viewing angle), and the opening structure 24 could include the three openings 25 corresponding to the three bending ribs 21 respectively.

In this embodiment, the fixing plate 202 could have at least one protruding pillar 206 (two shown in FIG. 8, but not limited thereto). The mounting plate 14 could further have a guiding slot 208, a protruding portion 210, and a positioning slot 212 corresponding to the protruding pillar 206, but not limited thereto, meaning that the present invention could adopt the design that the protruding pillar 206 protrudes from the mounting plate 14 and the guiding slot 208, the protruding portion 210, and the positioning slot 212 are formed on the fixing plate 202. The guiding slot 208 is communicated with the positioning slot 212, and the protruding portion 210 is located between the guiding slot 208 and the positioning slot 212. The protruding pillar 206 is movably inserted into the guiding slot 208 for crossing the protruding portion 210 along the guiding slot 208 with rotation of the mounting plate 14 relative to the fixing plate 202 to be engaged with the positioning slot 212. Furthermore, a strip-shaped slot 214 is formed at two sides of the guiding slot 208 respectively (but not limited thereto, meaning that the present invention could adopt the design that the strip-shaped slot 214 is only formed at one side of the guiding slot 208), so as to enhance the structural elasticity of the guiding slot 208, the protruding portion 210, and the positioning slot 212 for preventing the protruding pillar 206 from being jammed with the guiding slot 208, the protruding portion 210, and the positioning slot 212.

Via the aforesaid design, when the user wants to embed the monitoring apparatus 200 in a mounting target (i.e. the ceiling structure 216 in FIG. 9), the user just needs to fix the fixing plate 202 on the embedded frame 204 embedded in the ceiling structure 216, or embed the mounting plate 202 and the embedded frame 204 in the ceiling structure 216 after fixing the mounting plate 202 in the embedded frame 204. Subsequently, the user could sleeve the guiding ring structure 22 of the fixing plate 202 on the guiding ring structure 18 of the mounting plate 14 connected to the main body 12 (e.g. by a screw locking process), and then could rotate the main body 12 to make the mounting plate 14 rotate relative to the fixing plate 202. During the aforesaid process, each bending rib 21 could rotate to be aligned with the corresponding opening 25 on the guiding ring structure 26 respectively so that the user could push the main body 12 upward to make each bending rib 21 on the guiding ring structure 18 pass through the corresponding opening 25 and make the elastic arm 34 located at a side of the bending rib 21 inserted into the sliding slot 28. At the same time, the protruding pillar 206 is also inserted into the guiding slot 208. Subsequently, the user could continue rotating the main body 12 until the bending rib 21 rotates to be engaged with the corresponding bending rib 26, the elastic arm 34 crosses the inclined-surface structure 30 along the sliding slot 28 to be engaged with the fixing slot 32, and the protruding pillar 206 crosses the protruding portion along the guiding slot 208 to be engaged with the positioning slot 212 so as to remind the user of stopping rotating the main body 12. In such a manner, via engagement of each bending rib 21 and the corresponding bending rib structure 26, engagement of the elastic arm 34 and the fixing slot 32, and engagement of the protruding pillar 206 and the positioning slot 212, the user could embed the monitoring apparatus 200 in the ceiling structure 216 (as shown in FIG. 9) quickly and conveniently without additionally utilizing a screwing tool (e.g. a screw driver), so as to efficiently solve prior art problem that the mounting process of the monitoring apparatus is time-consuming and strenuous and the monitoring apparatus falls from the user's hands easily during the mounting process to cause damage of the monitoring apparatus. In such a manner, the mounting convenience and safety of the monitoring apparatus 200 is greatly improved.

In practical application, as shown in FIG. 9, the mounting plate 14 could further have at least one hook rope 218 (one shown in FIG. 9, but not limited thereto). The fixing plate 202 could have a hole sheet 220 corresponding to the hook rope 218. The hook rope 218 is engaged with the hole sheet 220 to make the mount plate 14 with the main body 12 hung under the fixing plate 202 via the hook rope 218 when the mount plate 14 is not fixed on the fixing plate 202, so as to prevent accidental falling of the main body 12.

It should be mentioned that the guiding design of the guiding ring structures, the engagement design of the elastic arm 34 and the fixing slot 32, and the engagement design of the protruding pillar 206 and the positioning slot 212 could be omitted for simplifying the structural design of the monitoring apparatus of the present invention. For example, in another embodiment, the monitoring apparatus of the present invention could only utilize the bending rib structure of the mounting plate to rotate to be engaged with the bending rib structure after the bending rib structure passes through the opening structure of the fixing plate, to assemble the mounting plate with the fixing plate. As for the related description for this embodiment and other derived structural designs (e.g. the engagement design of the protruding pillar and the slot mentioned in the third embodiment could be applied to the first embodiment), it could be reasoned by analogy according to the aforesaid embodiments and omitted herein.

Compared with the prior art, the present invention adopts the design that the bending rib structure of the mounting plate rotates to be engaged with the bending rib structure of the fixing plate to complete assembly of the mounting plate and the fixing plate, so that the main body could be mounted on the mounting target via the mounting plate and the fixing plate. In such a manner, a user could mount the monitoring apparatus on a mounting target quickly and conveniently without additionally utilizing a screwing tool (e.g. a screw driver), so as to efficiently solve prior art problem that the mounting process of the monitoring apparatus is time-consuming and strenuous and the monitoring apparatus falls from the user's hands easily during the mounting process to cause damage of the monitoring apparatus. Accordingly, the mounting convenience and safety of the monitoring apparatus is greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A monitoring apparatus comprising:
a main body;
a mounting plate connected to the main body, a first bending rib structure protruding from the mounting plate; and
a fixing plate fixed to a mounting target and disposed opposite to the mounting plate, the fixing plate having a first opening structure corresponding to the first bending rib structure and a second bending rib structure laterally extending from the first opening structure, the first bending rib structure rotating with rotation of the mounting plate relative to the fixing plate to be engaged with the second bending rib structure when the mounting plate is connected to the fixing plate to make the first bending rib structure pass through the first opening structure, so as to fix the mounting plate to the fixing plate.

2. The monitoring apparatus of claim 1, wherein a first guiding ring structure protrudes from the mounting plate, a second guiding ring structure protrudes from the fixing plate, and a size of the second guiding ring structure is greater than a size of the first guiding ring structure so as to make the second guiding ring structure sleeve the first guiding ring structure for guiding the mounting plate to rotate on the fixing plate when the mounting plate is connected to the fixing plate.

3. The monitoring apparatus of claim 2, wherein the first bending rib structure is formed on the first guiding ring structure, and the first opening structure and the second bending rib structure are formed on the second guiding ring structure.

4. The monitoring apparatus of claim 3, wherein the second guiding ring structure has a sliding slot, an inclined-surface structure, and a fixing slot extending from a side of the second bending rib structure, the inclined-surface structure is located between the sliding slot and the fixing slot, an elastic arm protrudes from the mounting plate corresponding to the sliding slot, the elastic arm is movably inserted into the sliding slot for crossing the inclined-surface structure along the sliding slot to be engaged with the fixing slot with rotation of the mounting plate relative to the fixing plate.

5. The monitoring apparatus of claim 1, wherein at least one protruding pillar is formed on one of the mounting plate and the fixing plate, a guiding slot, a protruding portion and a positioning slot are formed on the other one of the mounting plate and the fixing plate corresponding to the at least one protruding pillar, the guiding slot is communicated with the positioning slot, the protruding portion is located between the guiding slot and the positioning slot, and the at least one protruding pillar is movably inserted into the guiding slot for crossing the protruding portion along the guiding slot to be engaged with the positioning slot with rotation of the mounting plate relative to the fixing plate.

6. The monitoring apparatus of claim 5, wherein a strip-shaped slot is formed on at least one side of the guiding slot.

7. The monitoring apparatus of claim 1, wherein the fixing plate further has a second opening structure formed thereon and a containing slot laterally extending from the second opening structure, the monitoring apparatus further comprises an adapting plate, the adapting plate is fixed to the mounting target and has a protruding portion, and the protruding portion is used for rotating to abut against the containing slot after passing through the second opening structure with rotation of the adapting plate relative to the fixing plate, so as to connect the fixing plate to the adapting plate.

8. The monitoring apparatus of claim 7, wherein a first guiding ring structure protrudes from the fixing plate, a second guiding ring structure protrudes from the adapting plate, and a size of the second guiding ring structure is less than a size of the first guiding ring structure so as to make the first guiding ring structure sleeve the second guiding ring structure for guiding the fixing plate to rotate relative to the adapting plate when the fixing plate is connected to the adapting plate.

9. The monitoring apparatus of claim 8, wherein the first guiding ring structure has a third opening structure formed thereon, and the second opening structure and the containing slot are formed on the third opening structure.

10. The monitoring apparatus of claim 1, wherein the mounting plate has at least one hook rope, the fixing plate has a hole sheet corresponding to the at least one hook rope, and the at least one hook rope is engaged with the hole sheet to make the mounting plate connected to the fixing plate via the at least one hook rope.

11. The monitoring apparatus of claim 1, wherein the first bending rib structure comprises at least two bending ribs alternately formed on the mounting plate, the first opening structure comprises at least two openings respectively corresponding to the at least two bending ribs, and sizes of the at least two bending ribs are different from each other and conform to sizes of the at least two openings respectively, so as to make each bending rib only pass through the corresponding opening.
